(19) United States
(12) Patent Application Publication
(10) Pub. No.: US 2016/0065783 A1
(43) Pub. Date: Mar. 3, 2016

(54) IMAGE READING DEVICE

(71) Applicant: KYOCERA Document Solutions Inc., Osaka (JP)

(72) Inventor: Toshihiko Tanaka, Osaka (JP)

(21) Appl. No.: 14/833,169

(22) Filed: Aug. 24, 2015

(30) Foreign Application Priority Data
Aug. 27, 2014 (JP) 2014-172220

(51) Int. Cl. H04N 1/32; H04N 1/21; H04N 1/23; H04N 1/00

(52) U.S. Cl. CPC H04N 1/32454; H04N 1/00708; H04N 1/00766; H04N 1/00771; H04N 1/00779; H04N 1/2104; H04N 1/2392; H04N 1/32496; H04N 1/00769; H04N 1/00588; H04N 2201/0094; H04N 2201/0081; H04N 2201/214; H04N 2201/325

(57) ABSTRACT

This image reading device includes a determination unit and a control unit. The determination unit determines whether the total data size of all pages, which is a sum total of image data sizes of all the pages calculated based on the image data sizes accepted page by page by an acceptance unit, exceeds an allowable data size stored in a storage unit. If the determination unit determines that the total data size of all the pages, which is calculated based on the image data sizes accepted page by page by the acceptance unit, does not exceed the allowable data size stored in the storage unit, the control unit causes a reading unit to reread the images of the pages at the image data sizes accepted by the acceptance unit and causes an image data generation unit to generate image data of the images.

### INCORPORATION BY REFERENCE

The disclosure of Japanese Patent Application No. 2014-172220 filed on Aug. 27, 2014 including the specification, drawings and abstract is incorporated herein by reference in its entirety.

### BACKGROUND

The present disclosure relates to an image reading device.

Image processing apparatuses, typified by digital multi-function peripherals, are provided with an image reading device that reads images of documents. The images to be read by the image reading device may be images of a plurality of documents loaded into an auto document feeder (ADF) or images of a document placed on a platen. The image processing apparatuses form images, for example, using an image forming unit based on images read by the image reading device.

There are some known techniques of image reading.

A typical well-known image reading device includes an ADF unit that conveys a document onto a document glass, a light source that illuminates the document, an optical system that forms a document image utilizing reflected light from the document, a color image sensor that separates the formed document image into images of different colors to capture a color image, an image reading controller having a plurality of reading modes, and a carriage that sets an image reading position. The image reading controller includes a document attribute detection section that detects attributes of the document based on the image data of the different colors read out from the document image, and the document attribute detection section selects one of the reading modes based on the detected document attribute.

A typical well-known image reading system is mainly composed of a reading device capable of reading documents and a host computer. The host computer includes a storage unit that has a finite capacity and can read and write data, a setting selection unit that can select a read setting for a reading device, and a setting change unit that checks available area capacity of the storage unit at the start of reading operation by the reading device, compares the available area capacity with the data size of an image read by the reading device, and causes the setting selection unit to change the read setting if the data size of the image is greater than the available area capacity.

### SUMMARY

In one aspect of the present disclosure, an image reading device includes a reading unit, an image data generation unit, an input unit, a storage unit, an acceptance unit, a determination unit, and a control unit. The reading unit reads images of a plurality of pages. The image data generation unit generates image data based on the images read by the reading unit. The input unit enables input of an allowable data size prior to reading of the images by the reading unit. The allowable data size is a size of image data allowed to be generated. The storage unit stores the allowable data size input through the input unit. The acceptance unit accepts sizes of the image data, page by page, to be generated based on the images read by the reading unit. The determination unit determines whether the total data size of all the pages, which is a sum total of image data of all the pages calculated based on the image data sizes accepted page by page by the acceptance unit, exceeds the allowable data size stored in the storage unit. If the determination unit determines that the total data size of all the pages, which is calculated based on the image data sizes accepted page by page by the acceptance unit, does not exceed the allowable data size stored in the storage unit, the control unit causes the reading unit to reread the images of the plurality of pages at the image data sizes accepted by the acceptance unit and causes the image data generation unit to generate image data of the images reread.

### BRIEF DESCRIPTION OF THE DRAWINGS

FIG. 1 is a schematic perspective view showing the appearance of a digital multi-function peripheral to which an image processing apparatus including an image reading device according to the embodiment of the discloser is applied.

FIG. 2 is a block diagram showing the configuration of the digital multi-function peripheral shown in FIG. 1.

FIG. 3 is an external view schematically showing the configuration of an operation unit.

FIG. 4 is a schematic view of a part of the image reading device viewed from above.

FIG. 5 is a flow chart of processing steps performed by the digital multi-function peripheral including the image reading device according to the embodiment when a user uses the peripheral to read images of documents and create files for the read images.

FIG. 6 shows images of the documents to be loaded into an ADF.

FIG. 7 illustrates an example of a display screen on an operation unit, prompting the user to input the user's desired allowable data size.

FIG. 8 illustrates an example of the display screen on the operation unit, displaying generated page images to accept entries of the user's desired resolutions.

FIG. 9 illustrates an example of the display screen on the operation unit, displayed when the total data size of all the pages exceeds the allowable data size.

FIG. 10 illustrates an example of the display screen on the operation unit, prompting the user to perform a rereading operation on the images.

FIG. 11 is a flow chart of processing steps performed by an image reading device according to another embodiment of the disclosure.

FIG. 12 illustrates an example of the display screen on the operation unit, displayed when there is a difference in data size.

### DETAILED DESCRIPTION

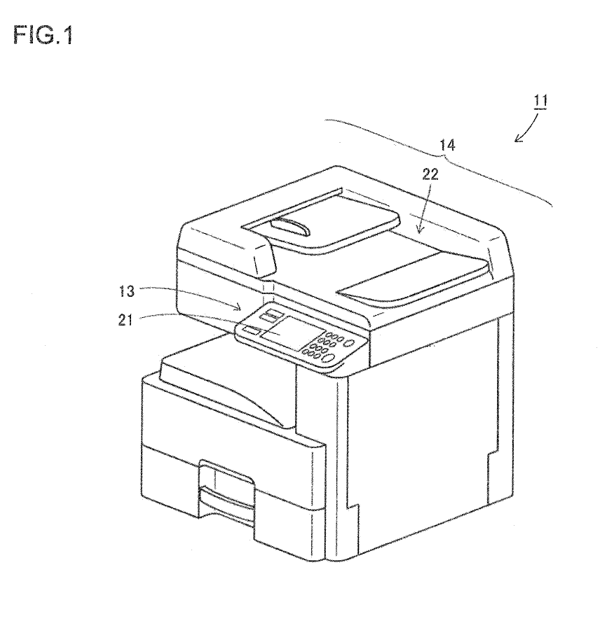

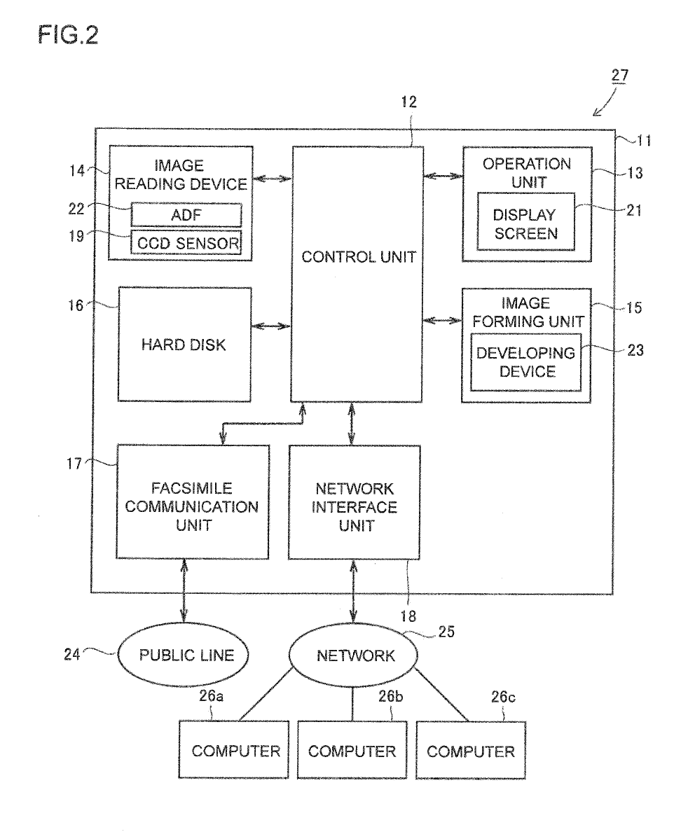

Embodiments of the present disclosure will be described below. First of all, a description will be made about the configuration of a digital multi-function peripheral to which an image processing apparatus including an image reading device according to an embodiment of the discloser is applied. FIG. 1 is a schematic view showing the appearance of the digital multi-function peripheral to which the image processing apparatus including the image reading device according to the embodiment of the discloser is applied. FIG. 2 is a block diagram showing the configuration of the digital multi-function peripheral to which the image processing apparatus including the image reading device according to the embodiment of the disclosure is applied.

Referring to FIGS. 1 and 2, the digital multi-function peripheral 11 includes a control unit 12, an operation unit 13, an image reading device 14, an image forming unit 15, a hard disk 16 serving as a storage unit, a facsimile communication unit 17, and a network interface unit 18 used to connect with a network 25. The control unit 12 controls over the entire digital multi-function peripheral 11. The operation unit 13 includes a display screen 21 that displays information submitted from the digital multi-function peripheral 11 and entries made by users. The operation unit 13 allows the users to input image forming conditions, such as the number of copies and gradation degrees, and to turn on or off the power source. The image reading device 14 includes an auto document feeder (ADF) 22 that automatically conveys documents loaded thereon to a reading position and a charge coupled device (CCD) sensor 19 that functions as a reading unit for reading images of the documents. The image reading device 14 reads images of documents and printed matter. The image forming unit 15 includes a development device 23 that develops images with toner. The image forming unit 15 forms images based on read images or image data transmitted via the network 25. The hard disk 16 stores the transmitted image data, the input image forming conditions, and so on. The facsimile communication unit 17 is connected to a public line 24 and performs facsimile transmission and reception. The digital multi-function peripheral 11 also includes a dynamic random access memory (DRAM) enabling writing and reading of image data, and other components, but their pictorial representations and descriptions are omitted. The arrows in FIG. 2 indicate control signal flows and data flows relating to control operations and images.

The digital multi-function peripheral 11 operates as a copier by causing the image forming unit 15 to form an image from an image of a document read by the image reading device 14. In addition, the digital multi-function peripheral 11 operates as a printer by receiving image data transmitted via the network interface unit 18 from computers 26a, 26b, 26c connected to the network 25 and causing the image forming unit 15 to form an image using the image data and print it on paper. In other words, the image forming unit 15 operates as a printing unit for printing required images. Furthermore, the digital multi-function peripheral 11 operates as a facsimile by receiving image data transmitted from the public line 24 through the facsimile communication unit 17 and causing the image forming unit 15 to form an image using the image data via the DRAM, or by transmitting image data of a document, read by the image reading device 14, through the facsimile communication unit 17 to the public line 24. In short, the digital multi-function peripheral 11 has a plurality of functions relating to image processing, such as a copying function, a printer function, and a facsimile function. The digital multi-function peripheral 11 also has a function of minutely setting each of the functions.

The digital multi-function peripheral 11 is included in an image processing system 27. The image processing system 27 mainly includes the digital multi-function peripheral 11 and the plurality of computers 26a, 26b, 26c. More specifically, the image processing system 27 includes the digital multi-function peripheral 11 configured as described above and the computers 26a, 26b, 26c connected to the digital multi-function peripheral 11 via the network 25. This embodiment shows three computers 26a to 26c. Each of the computers 26a to 26c can make a print request to the digital multi-function peripheral 11 via the network 25 to perform printing. The digital multi-function peripheral 11 may be connected to the computers 26a to 26c with wires, such as local area network (LAN) cables, or may be wirelessly connected. In addition, other digital multi-function peripherals and servers may be connected within the network 25.

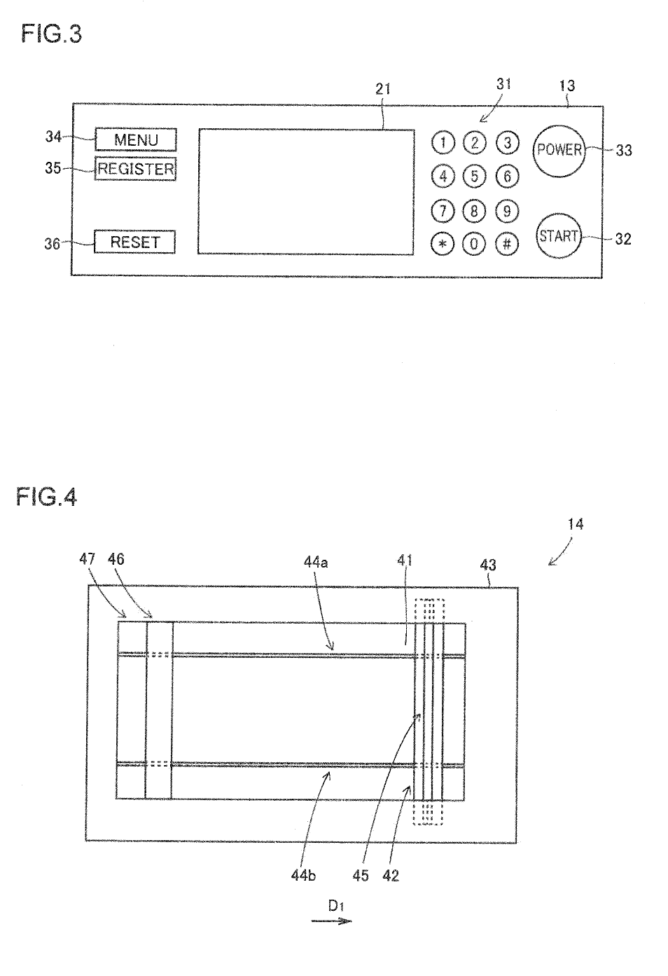

Next, the aforementioned operation unit 13 will be further described in detail. FIG. 3 is an external view schematically showing the configuration of the operation unit 13. Referring to FIG. 3, the operation unit 13 includes numeric keys 31 including number keys 0 to 9 used to input the number of copies or the like and symbol keys like “*” and “#”, a start key 32 used to instruct to start printing and sending a fax, a power key 33 used to turn on and off the power source of the digital multi-function peripheral 11, a menu key 34 used to select one of functions, such as a printer function and a copy function, of the digital multi-function peripheral 11, a register key 35 used to instruct to register various image forming conditions and users' information, a reset key 36 used to cancel the instructions input by users with the numeric keys 31 and the other keys, and the aforementioned display screen 21. The display screen 21 is a liquid crystal display with a touch panel function that allows users to input image forming conditions and to select from among the functions by depressing the display screen 21 with their fingers.

Next, brief description will be made about the configuration of the aforementioned image reading device 14. FIG. 4 is a schematic view of a part of the image reading device 14 viewed from above. Referring to FIGS. 1 to 4, the image reading device 14 includes a platen 41 on which a document with an image to be read is placed, and a carriage 42 that is movable in a sub-scanning direction indicated by Arrow D1 in FIG. 4 or the reverse direction and has a CCD sensor 19 that is an image sensor for reading the image of the document based on the reflected light from the document. The platen 41 is fitted in an opening of a housing 43 and is made of contact glass in this embodiment. The carriage 42 is guided by two metal rods 44a, 44b mounted in parallel with each other in the housing 43 and moves with power from a motor (not shown). The carriage 42 includes an exposure lamp 45 that emits light upwardly from below the platen 41, a plurality of mirrors (not shown), and a lens (not shown) that collects and condenses the light. The carriage 42 moves in the sub-scanning direction while the exposure lamp 45 emits light toward the platen 41 to read the image of the document. The platen 41, more specifically, the document placed on the platen 41 reflects the light, and the reflected light is collected by the mirrors and lens and enters the CCD sensor 19, thereby capturing the image of the document on the platen 41. Alternatively, the carriage 42 is anchored at a predetermined position 47 to read an image of a document fed by the ADF 22. The predetermined position 47 is located next to a reference strip 46 in the sub-scanning direction and is composed of a transparent material. The reference strip 46 indicates a reference position referred to place a document on the platen 41. The image reading device 14 can obtain color information of not only monochrome documents, but also color documents.

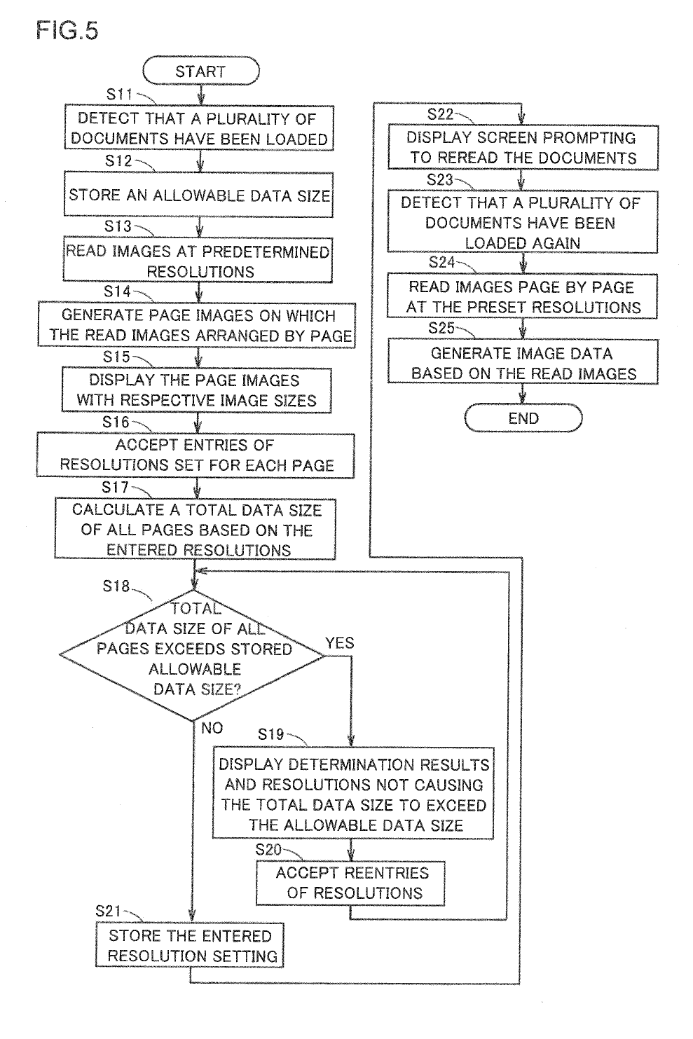

Next, description will be made on how to read images and generate the image data with the digital multi-function peripheral 11 according to the embodiment of the disclosure. FIG. 5 is a flow chart of processing steps for reading images of documents and generating the image data. The image data is generated, for example, in a file format, such as a portable document format (PDF). In this processing, the control unit 12 and some other components operate as an image data generation unit.

Referring to FIG. 5, firstly, a user loads documents to be read into the ADF 22. The digital multi-function peripheral 11 detects that the documents have been loaded (step S11 in FIG. 5, “step” will be omitted hereinafter).

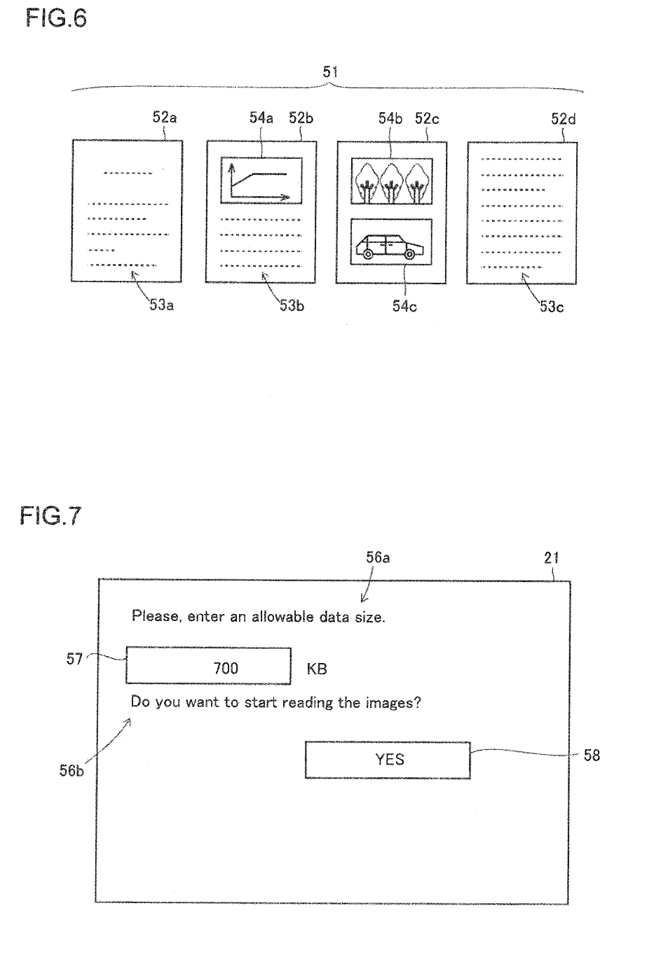

The images to be read from the documents will be described. FIG. 6 is a schematic view of the documents with the images to be read. Referring to FIG. 6, a document set 51 is composed of four pages 52a, 52b, 52c, 52d. The first page 52a contains only a text image 53a. The second page 52b contains a diagram image 54a of a graph and a text image 53b. The diagram image 54a occupies almost an upper half of the page 52b, while the text image 53b occupies almost a lower half of the page 52b. The third page 52c contains a picture image 54b of a photograph of trees, and a picture image 54c of a photograph of a car. The picture image 54b occupies almost an upper half of the page 52c, while the picture image 54c occupies almost a lower half of the page 52c. The fourth page 52d contains only a text image 53c. The ratio of the text image 53a to the entire area of the page 52a is set to be smaller than the ratio of the text image 53c to the entire area of the page 52d.

The user loads the document set 51 composed of the four pages 52a to 52d into the ADF 22 of the image reading device 14. Once the digital multi-function peripheral 11 detects that the document set has been loaded into the ADF 22, a screen appears on the display screen 21 of the operation unit 13 to prompt the user to input an allowable data size, which is a size of image data allowed to be generated.

FIG. 7 illustrates an example of the display screen 21 on the operation unit 13 to prompt the user to input the allowable data size. Referring to FIG. 7, the display screen 21 of the operation unit 13 shows a message 56a “Please, enter an allowable data size.”, an allowable data size input field 57, an inquiry message 56b “Do you want to start reading the image?”, and a selection key 58 labeled “YES” and used to start image reading upon being depressed. The user enters an allowable data size by inputting a numeric value using the numeric keys 31 or the like on the operation unit 13. In this embodiment, the user enters 700 KB (kilobyte). The operation unit 13 operates as an input unit in this processing step. Upon accepting the entry through the display screen 21 on the operation unit 13, the digital multi-function peripheral 11 stores data associated with the allowable data size into the hard disk 16 (S12).

After depression of the selection key 58 has been detected, the images of the document set 51 are read at predetermined resolutions, specifically, the images of the first and fourth pages are read at 100 dpi (dots per inch), and the images of the second and third pages are read at 200 dpi in this embodiment (S13). In this processing step, the images of the document set 51 are read in the order from the first page to fourth page. Subsequent to the reading process of the images of the document set 51, page images with the read images arranged by page are generated (S14). In this embodiment, the digital multi-function peripheral 11 includes a page image generation unit that generates page images with the read images arranged by page based on the images of the pages read by the reading unit.

Next, the generated page images are displayed (S15). These page images are preview images of the respective image data items generated. Referring to the page images, the user inputs desired resolutions for the images that are accepted page by page (S16). In this processing step, the control unit 12 operates as an acceptance unit.

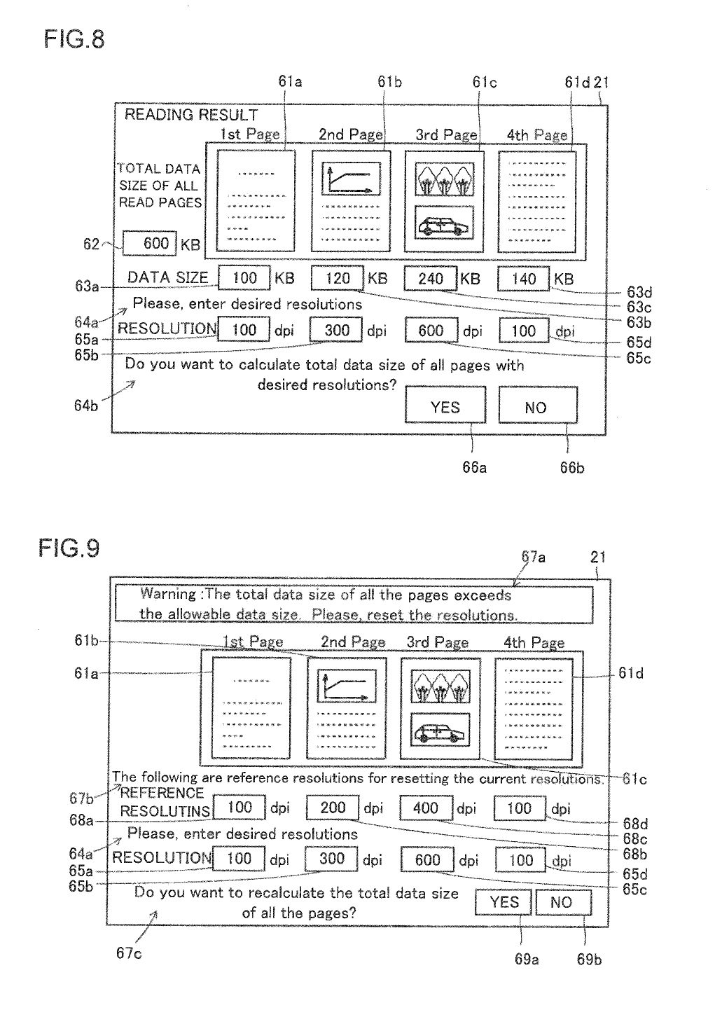

FIG. 8 illustrates an example of the display screen 21 on the operation unit 13, displaying the generated page images to accept entries of the user's desired resolutions. Referring to FIG. 8, the display screen 21 of the operation unit 13 shows the preview images, which are reading results, more specifically, a thumbnail image 61a generated by reading the first page 52a of the document set 51, a thumbnail image 61b generated by reading the second page 52b of the document set 51, a thumbnail image 61c generated by reading the third page 52c of the document set 51, and a thumbnail image 61d generated by reading the fourth page 52d of the document set 51.

The display screen 21 of the operation unit 13 also shows a window 62 that indicates the total data size of all the pages when the document set 51 composed of the pages 52a to 52d are read at the above-described predetermined resolutions, a window 63a that indicates the image data size of a file created for the image of the first page 52a, a window 63b that indicates the image data size of a file created for the image of the second page 52b, a window 63c that indicates the image data size of a file created for the image of the third page 52c, and a window 63d that indicates the image data size of a file created for the image of the fourth page 52d. In this example, the window 62 indicates 600 KB as the total data size of all the pages when all the images are read at 100 dpi and 200 dpi resolutions as described above.

Furthermore, the display screen 21 of the operation unit 13 shows a message 64a “Please, enter desired resolution”, an input field 65a into which a resolution desired for the first page 52a is input, an input field 65b into which a resolution desired for the second page 52b is input, an input field 65c into which a resolution desired for the third page 52c is input, an input field 65d into which a resolution desired for the fourth page 52d is input, an inquiry message 64b “Do you want to calculate the total data size of all pages with desired resolutions?”, a selection key 66a labeled “YES” and used to calculate the total data size of all the pages upon being depressed, and a selection key 66b labeled “NO” and used to clear all the resolution values input in the input fields 65a to 65d upon being depressed.

At this stage, the user checks the display of the thumbnail images 61a to 61d and windows 63a to 63d, and inputs desired resolutions page by page in the input fields 65a to 65d to set up. Users tend to not choose such higher resolutions for pages with many text images, but to choose resolutions as high as possible for pages with many picture images. In this example, the user inputs 100 dpi as a desired resolution for the first and fourth pages containing text images. For the second page containing a text image and a diagram image, the user inputs 300 dpi as a desired resolution. For the third page containing two picture images, the user inputs 600 dpi as a desired resolution. The desired resolutions are entered by inputting numeric values using the numeric keys 31 or the like.

The digital multi-function peripheral 11 accepts the desired resolutions input in the input fields 65a to 65d (S16). After detecting that the user has depressed the selection key 66a labeled “YES”, the digital multi-function peripheral 11 calculates the total data size of all the pages based on the entered desired resolutions (S17). Then, the previously accepted allowable image data size, that is, the allowable data size input in the input field 57 and stored, is compared with the total data size of all the pages calculated based on the resolutions input in the input fields 65a to 65d. After comparison, determination is made whether the calculated total data size of all the pages exceeds the allowable data size (S18). In this processing step, the control unit 12 operates as a determination unit.

If it is determined that the calculated total data size of all the pages exceeds the previously accepted allowable data size (YES in S18), the determination and resolutions not causing the total data size of all the pages to exceed the allowable data size are displayed (S19). In this example, if the total data size of all the pages, which is calculated based on the desired resolutions, exceeds the entered allowable data size, i.e., 700 KB, the display screen 21 displays that the total data size of all the pages exceeds the allowable data size. In this processing step, the operation unit 13 operates as a notification unit.

FIG. 9 illustrates an example of the display screen 21 on the operation unit 13 when the total data size of all the pages exceeds the allowable data size. Referring to FIG. 9, the display screen 21 shows a warning message 67a “Warning: The total data size of all the pages exceeds the allowable data size. Please, reset the resolutions.”, and the four thumbnail images 61a to 61d shown on the display screen 21 in FIG. 8. The user sees the display and understands that the total data size of all the pages reproduced at the desired resolutions will exceed the allowable data size.

The display screen 21 shows a message 67b “The following are reference resolutions for resetting the current resolutions.”, a window 68a indicating a reference resolution that will be used to read the image of the first page 52a, but will not cause the total data size to exceed the allowable data size, a window 68b indicating a reference resolution that will be used to read the image of the second page 52b, but will not cause the total data size to exceed the allowable data size, a window 68c indicating a reference resolution that will be used to read the image of the third page 52c, but will not cause the total data size to exceed the allowable data size, and a window 68d indicating a reference resolution that will be used to read the image of the fourth page 52d, but will not cause the total data size to exceed the allowable data size. The user sees the values in the windows 68a to 68d and can recognize the upper limit of the allowable data size for reference sake.

The display screen 21 also shows a message 64a “Please, enter desired resolutions.” as shown in the display screen 21 of FIG. 8, the input fields 65a to 65d, an inquiry message 67c “Do you want to recalculate the total data size of all the pages?”, a selection key 69a labeled “YES” and executing recalculation of the total data size of all the pages upon being depressed, a selection key 69b labeled “NO” and clearing all the reference resolution values displayed in the windows 68a to 68d upon being repressed.

The user refers to the reference resolutions in the windows 68a to 68d to input desired resolutions page by page in the input fields 65a to 65d again. Specifically, the user inputs values in the input fields 65a to 65d using the numeric keys 31 or the like again so that the total data size for all the pages does not exceed the allowable data size.

After detecting that the user has depressed the selection key 69a labeled “YES”, the digital multi-function peripheral 11 recalculates the total data size of all the pages based on the entered desired resolutions (S17). Then, the digital multi-function peripheral 11 compares the previously accepted allowable data size, i.e., the allowable data size input in the input field 57, with the total data size of all the pages recalculated based on the resolutions input in the input fields 65a to 65d, and determines whether the recalculated total data size of all the pages exceeds the previously accepted allowable data size (S18).

If it is determined that the recalculated total data size of all the pages does not exceed the previously input allowable data size (NO in S18), the input resolution settings are stored in the hard disk 16 (S21). The user is then prompted to cause the digital multi-function peripheral 11 to reread the documents.

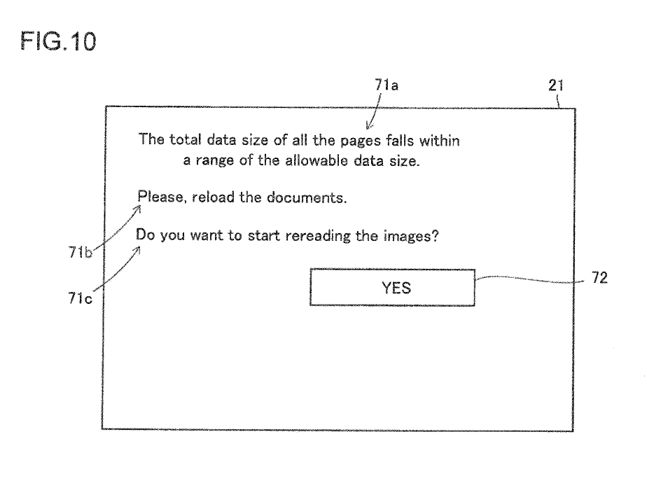

FIG. 10 illustrates an example of the display screen 21 on the operation unit 13 to prompt the user to perform rereading operation on the images. Referring to FIG. 10, the display screen 21 shows a message 71a “The total data size of all the pages falls within a range of the allowable data size” to indicate that the recalculated total data size of all the pages does not exceed the previously input allowable data size, a message 71b “Please, reload the documents” to prompt the user to load the documents again, an inquiry message 71c “Do you want to start rereading the image?”, and a selection key 72 labeled “YES” and performing a rereading operation on the images of the documents upon being depressed.

The user is prompted by the messages 71a to 71c to reload the document set 51 into the ADF 22 and depresses the selection key 72. After detecting that the document set 51 has been reloaded again (S23), the digital multi-function peripheral 11 starts rereading the images of the document set 51 in response to depression of the selection key 72 (S24).

The images are read at the resolutions that have been input in the input fields 65a to 65d and stored in the hard disk 16. Specifically, the images on the first and fourth pages are read at 100 dpi resolution, the images on the second page are read at 200 dpi resolution, and the images on the third page are read at 400 dpi resolution. With the data of the read images, image data is generated (S25). In this manner, the images are read and the image data of the images is generated.

On the other hand, if it is determined that the total data size of all the pages calculated based on the firstly entered resolutions does not exceed the previously accepted allowable data size (NO in S18), the document set 51 is reread through steps S21 to S25 to generate the image data. In this case, reading the document set 51 twice enables generation of image data satisfying the user's desire.

Thus, the digital multi-function peripheral 11 is provided with the acceptance unit that accepts the sizes of image data, page by page, to be generated based on the images read by the image reading device 14. Therefore, the digital multi-function peripheral 11 can read the images at the user's desired image data sizes for each page. In addition, the determination unit determines whether the total data size of all the pages, which is calculated based on the image data sizes accepted page by page by the acceptance unit, exceeds the allowable data size stored in the hard disk 16. If the determination unit determines that the total data size of all the pages, which is calculated based on the image data sizes accepted page by page by the acceptance unit, does not exceed the allowable data size stored in the hard disk 16, the image reading device 14 rereads the images of the plurality of pages at the image data sizes accepted by the acceptance unit, and the image data generation unit generates image data of the images. According to the above-described processing, the generated image data does not exceed the allowable data size desired by the user. Therefore, the digital multi-function peripheral 11 can read the images and generate the image data of the images to meet the user's desire.

If the determination unit determines that the total data size of all the pages, which is calculated based on the changed image data sizes accepted page by page by the acceptance unit, exceeds the allowable data size stored in the hard disk 16, the user is notified of the determination, and therefore can readily recognize that the total data size of all the pages exceeds the allowable data size. This notification helps the user input resolutions not causing the total data size to exceed the allowable data size to perform a reading operation on the images, thereby enabling reading of the images and generation of image data that meet the user's desire.

Also, if the determination unit determines that the total data size of all the pages, which is calculated based on the changed image data sizes accepted page by page by the acceptance unit, exceeds the allowable data size stored in the hard disk 16, the user is notified of the determination and is also notified of image data sizes for each page so that the total data size of all the pages accepted by the acceptance unit does not exceed the allowable data size stored in the hard disk 16. Referring to this notification, the user can readily input desired resolutions in a range that does not cause the total data size of all the pages to exceed the allowable data size.

In the above-described embodiment, the order in which the images are read may be stored. Specifically, the determination unit determines whether the order in which the images of the pages are reread by the reading unit is different from the order in which the images of the pages were read the last time by the reading unit. If the determination unit determines the orders are different from each other, the control unit can notify the user of the determination.

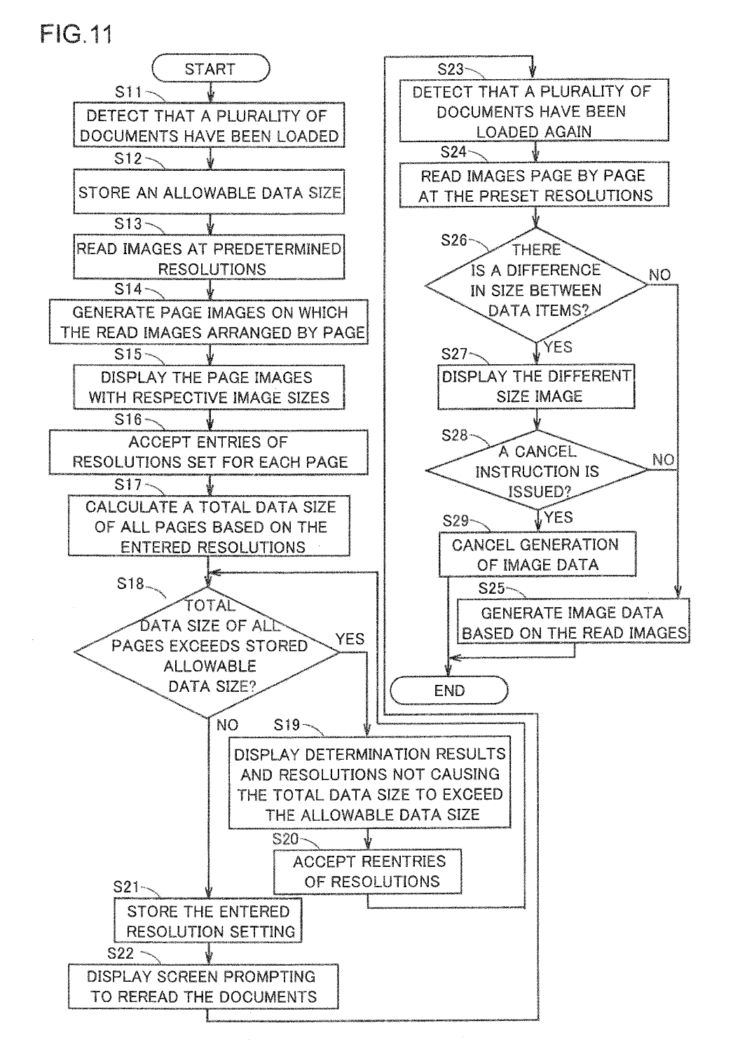

FIG. 11 is a flow chart of processing steps for reading images of documents and generating image data of the images in the aforementioned case. FIG. 11 corresponds to the flow chart in FIG. 5.

Referring to FIGS. 5 and 11, the same steps are taken from S11 to S20 as those in FIG. 5, and therefore the description about steps S11 to S20 are omitted. In S21, the entered resolution settings and the order of the read images are stored. In this example, data of a 100 dpi image, a 200 dpi image, a 400 dpi image, and a 100 dpi image in this order is stored.

Subsequently, in the same manner as shown in FIG. 5, the digital multi-function peripheral 11 displays a screen that prompts the user to reload the documents (S22), detects that the documents have been reloaded (S23), and starts reading the images at the resolutions specified page by page (S24). Then, it is determined whether the data sizes are different for each page (S26). Specifically, it is determined if there is a difference between the data size of a file generated for the first page after being read and the data size of the image read the previous time at 100 dpi. If there is no difference, the image on the second page is read to be successively determined if there is a difference. This process is performed until the last page, and if there is no difference (NO in S26), it is determined that the pages of the document set have been read in order and files are generated based on the read images in the same manner as FIG. 5.

On the other hand, for example, if the second page and the first page are misplaced at the second loading, it will be determined that there is a difference between the data size of a file generated for the first page after being read and the data size of the image read the previous time at 100 dpi (YES in S26). In short, it is determined that the order has been changed.

Then, the image different in size from the previous image is displayed and the process is suspended (S27). In addition, the digital multi-function peripheral 11 displays a screen notifying the user that the order has been changed and prompting the user to input an instruction subsequent to this process.

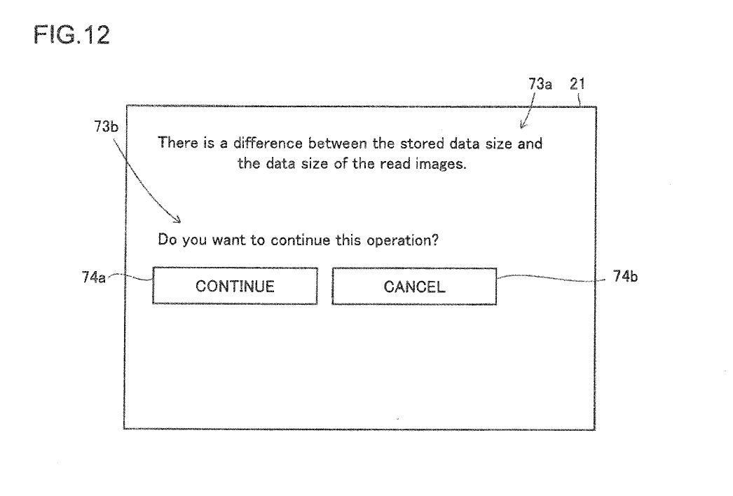

FIG. 12 illustrates an example of the display screen 21 on the operation unit 13 when there is a difference in data size. Referring to FIG. 12, the display screen 21 shows a message 73a “There is a difference between the stored data size and the data size of the read images”, an inquiry message 73b “Do you want to continue this operation?”, a selection key 74a labeled “Continue” and used to continue the operation upon being depressed, and a selection key 74b labeled “Cancel” and used to cancel the operation upon being depressed.

The user acknowledges the messages 73a, 73b. If the user wants to continue the operation without concern for the order in which the images are read or for other reasons, the user depresses the selection key 74a labeled “Continue”. In response to the depression of the selection key 74a, the digital multi-function peripheral 11 determines that no cancel instruction has been issued (NO in S28). With the determination, the digital multi-function peripheral 11 generates files based on the read images (S25).

On the other hand, if the user gives priority to the order in which the images are read, or other factors, and wants to stop further operation, the user depresses the selection key 74b labeled “Cancel”. In response to the depression of the selection key 74b, the digital multi-function peripheral 11 determines that a cancel instruction has been issued (YES in S28). With the determination, the digital multi-function peripheral 11 cancels the operation. Then, the user correctly reorders the pages, more specifically, rearranges the pages in the same order as when the resolutions were entered, and performs a rereading operation on the images.

According to the configuration, the images can be read in the order satisfying the user's requirement, thereby generating files further satisfying the user's desire.

Although the digital multi-function peripheral 11 is configured to include the aforementioned components in the above-described embodiment, the present disclosure is not limited thereto, and the image reading device itself can be configured to include the aforementioned components including the hard disk as a storage unit. Specifically, an image reading device according to another embodiment of the present disclosure includes a reading unit, an image data generation unit, an input unit, a storage unit, an acceptance unit, a determination unit, and a control unit. The reading unit reads images of a plurality of pages. The image data generation unit generates image data based on the images read by the reading unit. The input unit enables input of an allowable data size prior to reading of the images by the reading unit. The allowable data size is a size of image data allowed to be generated. The storage unit stores the allowable data size input through the input unit. The acceptance unit accepts sizes of image data, page by page, to be generated based on the images read by the reading unit. The determination unit determines whether the total data size of all the pages, which is a sum total of image data of all the pages calculated based on the image data sizes accepted page by page by the acceptance unit, exceeds the allowable data size stored in the storage unit. If the determination unit determines that the total data size of all the pages, which is calculated based on the image data sizes accepted page by page by the acceptance unit, does not exceed the allowable data size stored in the storage unit, the control unit causes the reading unit to reread the images of the plurality of pages at the image data sizes accepted by the acceptance unit and causes the image data generation unit to generate image data of the images reread.

Although the number of the reference resolution is one for each page in the above-described embodiment, the present disclosure is not limited thereto, and a plurality of reference resolutions can be displayed or none of the reference resolutions can be displayed. Also, in the case where the determination unit determines that the total data size of all the pages, which is calculated based on the changed image data sizes accepted page by page by the acceptance unit, exceeds the allowable data size stored in the storage unit, the control unit is configured to notify the user of the determination; however, the present disclosure is not limited thereto, and the control unit can be configured to immediately cancel generation of image data in response to the determination.

In addition, the input unit provided in the above-described embodiments is to change resolutions; however, the present disclosure is not limited to resolutions, and can employ, for example, an input unit that is to change reading modes so as to read a full color image in a black-and-white mode, or an input unit that is to change the size of an image by reducing the read image from an image of A4 size to an image of A5 size or A6 size, for the purpose of changing the data size.

Furthermore, the notification unit is configured to display data sizes and so on, using a display in the above-described embodiments; however, the present disclosure is not limited thereto, and, for example, the notification unit can be configured to send a notification by voice or to send a notification by a display and voice.

It should be understood that the embodiments and examples disclosed herein are illustrative and non-restrictive in every respect. The scope of the present disclosure is defined by the terms of the claims, rather than by the foregoing description, and is intended to include any modifications within the scope and meaning equivalent to the terms of the claims.

The image reading device according to the present disclosure is effectively used especially to address the requirement to read images and generate image data of the images to satisfy a user's desire.

What is claimed is:

1. An image reading device comprising:
a reading unit that reads images of a plurality of pages;
an image data generation unit that generates image data based on the images read by the reading unit;
an input unit that enables input of an allowable data size prior to reading of the images by the reading unit, the allowable data size being a size of image data allowed to be generated;
a storage unit that stores the allowable data size input through the input unit;
an acceptance unit that accepts sizes of the image data, page by page, to be generated based on the images read by the reading unit;
a determination unit that determines whether a total data size of all the pages, which is a sum total of image data sizes of all the pages calculated based on the image data sizes accepted page by page by the acceptance unit, exceeds the allowable data size stored in the storage unit; and
a control unit that, if the determination unit determines that the total data size of all the pages, which is calculated based on the image data sizes accepted page by page by the acceptance unit, does not exceed the allowable data size stored in the storage unit, causes the reading unit to reread the images of the pages at the image data sizes accepted by the acceptance unit and causes the image data generation unit to generate image data of the images reread.

2. The image reading device according to claim 1, wherein
if the determination unit determines that the total data size of all the pages, which is calculated based on changed image data sizes accepted page by page by the acceptance unit, exceeds the allowable data size stored in the storage unit, the control unit provides notification of the determination.

3. The image reading device according to claim 2, wherein
if the determination unit determines that the total data size of all the pages, which is calculated based on the changed image data sizes accepted page by page by the acceptance unit, exceeds the allowable data size stored in the storage unit, the control unit provides notification of the determination and also provides notification of image data sizes for each page that do not cause the total data size of all the pages accepted by the acceptance unit to exceed the allowable data size stored in the storage unit.

4. The image reading device according to claim 2, wherein
the control unit provides the notification through a display.

5. The image reading device according to claim 1, wherein
the control unit provides notification of sizes of image data page by page.

6. The image reading device according to claim 1 comprising:
a page image generation unit that generates page images with the read images arranged by page based on the images of the pages read by the reading unit, wherein
the control unit displays the page images generated by the page image generation unit on the display.

7. The image reading device according to claim 1, wherein
the determination unit determines whether the order in which the images of the pages are reread by the reading unit is different from the order in which the images of the pages were read the last time by the reading unit, and
if the determination unit determines the orders are different from each other, the control unit provides notification of the determination.
